(19) United States
(12) Patent Application Publication
(10) Pub. No.: US 2006/0053639 A1
(43) Pub. Date: Mar. 16, 2006

(54) Replacement blade and holder for reciprocating saw

(75) Inventor: Takasuke Nakanishi, Kanuma-shi (JP)

Correspondence Address: NOVAK DRUCE DELUCA & QUIGG, LLP, 1300 EYE STREET NW, SUITE 400 EAST, WASHINGTON, DC, 20005, US

(73) Assignee: NAKANISHI Inc.

(21) Appl. No.: 11/224,226

(22) Filed: Sep. 13, 2005

(30) Foreign Application Priority Data
Sep. 14, 2004 (JP) 2004-267052

(51) Int. Cl. B26B 1/00

(52) U.S. Cl. 30/329

(57) ABSTRACT

The present invention relates to a replacement blade and holder assembly for a reciprocating saw. The assembly includes a blade member having a cutting edge for cutting a treatment site, and a holder to which the blade member is detachably fixed. The blade member has an elongate aperture and a slit, and the holder has a first engagement pin protruding therefrom for detachably engaging in the elongate aperture in the blade member, and a second engagement pin protruding therefrom for detachably engaging in the slit in the blade member. The holder has a fixing end engagement member for detachably engaging with a fixing end of the blade member to restrict lateral displacement of the blade member. The present invention also relates to the blade for the assembly and the holder for the assembly.

### FIELD OF ART

The present invention relates to a replacement blade and holder assembly for a reciprocating saw used as a medical instrument or the like means.

### BACKGROUND ART

Medical handpieces are conventionally known, having a detachable surgical tool, such as a cutting blade for cutting bone. The blade of such medical handpieces is replaced for each use for hygienic reasons, or for keeping the blade sharp. Conventional blades for replacement are shown in FIGS. 5 and 6, wherein replacement blade 50 shown in FIG. 5 has a blade portion 51 and shaft portion 52 formed integrally with each other, whereas in replacement blade 60 shown in FIGS. 6(a) to 6(c), blade member 61 is formed separately from and detachably attached to shaft member 62.

More specifically, in the replacement blade 60 shown in FIGS. 6(a) to 6(c), the blade member 61 has elongate engagement aperture 63 formed in the proximal portion thereof. The elongate aperture 63 has small diameter portion 63a and large diameter portion 63b. The shaft member 62 has protrusion 64 formed in the distal portion thereof for engagement in the elongate aperture 63. On the surface of the protrusion 64 in its lower portion, groove 65 is formed so that the peripheral edge 63c of the elongate aperture 63 fits in the groove 65.

The replacement blade 50 of FIG. 5 as a whole is replaced and discarded as medical waste after each use, which is uneconomical and imposes problems in environmental hygiene.

In the replacement blade 60 of FIG. 6, the shaft member 62 is used a plurality of times, and only the blade member 61 is replaced for each use. Thus, compared to the replacement blade 50 of FIG. 5, this blade 60 is improved in the light of economy and environmental hygiene.

For replacing the blade member 61 of the replacement blade 60, the proximal end portion 63d of the blade member 61 is pressed against the top surface of the protrusion 64, and slid in the direction of arrow A in FIG. 6(c) while the blade member 61 is flexed, to fit the protrusion 64 in the elongate aperture 63 with the peripheral edge portion 63c of the aperture being fitted in the groove 65. Then the blade member 61 is slightly drawn back in the direction of arrow B in FIG. 6(c) to fit the proximal end portion 63d of the blade member 61 in recess 66. Since the blade member 61 is required to be flexed in this way for attachment and detachment, the blade member 61 is inevitably limited to a thin blade for allowing flexion.

The replacement blades now in practical use are usually about 0.3 to 1.0 mm thick. However, for flexing the blades for attachment and detachment, the thickness of the blades could be about 0.4 mm at the maximum. On the other hand, when the blades are required to have sufficient rigidity, the blades need to be thicker than this. Thus the replacement blade 60 of FIG. 6 cannot provide sufficient rigidity.

### SUMMARY OF THE INVENTION

The present invention aims to solve the above problems. It is therefore an object of the present invention to provide a replacement blade and holder assembly for a reciprocating saw, wherein even a hardly flexible thick blade may be used as a single-use replacement blade member, and securely attached to and detached from the holder by simple operation.

It is another object of the present invention to provide a replacement blade for such a replacement blade and holder assembly for a reciprocating saw.

It is yet another object of the present invention provide a holder for such a replacement blade and holder assembly for a reciprocating saw.

According to the present invention, there is provided a replacement blade and holder assembly for a reciprocating saw comprising:

a blade member having a cutting edge for cutting a treatment site, and

a holder to which said blade member is detachably fixed,

wherein said blade member has an elongate aperture and a slit,

wherein said holder has a first engagement pin protruding therefrom for detachably engaging in said elongate aperture in the blade member, and a second engagement pin protruding therefrom for detachably engaging in said slit in the blade member, and

wherein said holder has a fixing end engagement member for detachably engaging with a fixing end of the blade member to restrict lateral displacement of the blade member.

According to the present invention, there is also provided a replacement blade for use with a holder in the above assembly, comprising a blade member to be detachably fixed to the holder having a first and second engagement pins, said blade member having a cutting edge for cutting a treatment site, an elongate aperture in which the first engagement pin on the holder is to be detachably engaged, and a slit in which the second engagement pin on the holder is to be detachably engaged.

According to the present invention, there is also provided a holder for use with a replacement blade in the above assembly, wherein said replacement blade having an elongate aperture and a slit is to be detachably fixed to said holder, said holder comprising a first engagement pin protruding therefrom for detachably engaging in the elongate aperture in the blade, a second engagement pin protruding therefrom for detachably engaging in the slit in the blade, and a fixing end engagement member for detachably engaging with a fixing end of the blade to restrict lateral displacement of the blade.

In the replacement blade and holder assembly for a reciprocating saw according to the present invention, by fitting the first engagement pin on the holder in the elongate aperture in the blade member, and pivoting the blade member on the first engagement pin, the slit in the blade member is fitted on or released from the second engagement pin on the holder. When the first and second engagement pins on the holder are in engagement in the elongate aperture and the slit in the blade member, respectively, the fixing end engagement member engages with the fixing end of the blade member. By employing such one-touch pivotal attachment/detachment mechanism, the assembly of the present invention allows attachment and detachment of even a thick, rigid blade member as a single-use replacement blade member through easy operation. Further, the engagement between the engagement pins and the elongate aperture and the slit restricts axial displacement of the blade member, whereas the engagement between the fixing end engagement member and the fixing end of the blade member restricts lateral displacement of the blade member. Thus the blade member is securely fixed to the holder during use of the reciprocating saw.

In the replacement blade and holder assembly of the present invention, the elongate aperture in the blade member may have a large diameter portion having a diameter larger than the diameter of the first engagement pin on the holder for allowing insertion and release of the first engagement pin, and a small diameter portion having a diameter substantially the same as the diameter of the first engagement pin for holding and restricting displacement of the first engagement pin.

With the elongate aperture formed in such a shape, the first engagement pin may be slid in and relative to the elongate aperture and the blade member may be pivoted on the first engagement pin, which facilitates attachment and detachment of the blade member.

In the replacement blade and holder assembly of the present invention, the slit in the blade member may be cured so as to allow insertion and release of the second engagement pin on the holder when the blade member is pivoted on the first engagement pin fitted in the elongate aperture.

With the slit formed in such a shape, the slit may be fitted on and released from the second engagement pin simply by pivoting the blade member on the first engagement pin, which minimizes the clearance between the first engagement pin and the elongate aperture and between the second engagement pin and the slit.

In the replacement blade and holder assembly of the present invention, the fixing end engagement member may be slidable, and may be urged with an elastic member into engagement with the fixing end of the blade member.

With such a structure, simply by sliding the fixing end engagement member with fingers, the blade member is allowed to pivot on the first engagement pin for attachment and detachment of the blade member easily to and from the holder. In reverse, simply by releasing the fingers from the fixing end engagement member after the blade member is pivoted into the predetermined position on the holder, the fixing end engagement member automatically engages with the fixing end of the blade member to hold it from releasing and prevent its lateral displacement.

### BRIEF DESCRIPTION OF THE DRAWINGS

FIG. 1 is a perspective view of an embodiment of the replacement blade and holder assembly for a reciprocating saw according to the present invention.

FIG. 2 is a side view of an embodiment of the blade member of the replacement blade and holder assembly for a reciprocating saw according to the present invention.

FIG. 3(a) is a side view of an embodiment of the replacement blade and holder assembly for a reciprocating saw according to the present invention, and FIG. 3(b) is a sectional view taken along lines IIIb-IIIb in FIG. 3(a).

FIGS. 4(a) to 4(c) illustrate the operation for attaching the blade member to the holder.

FIG. 5 is a perspective view of a conventional replacement blade for a reciprocating saw.

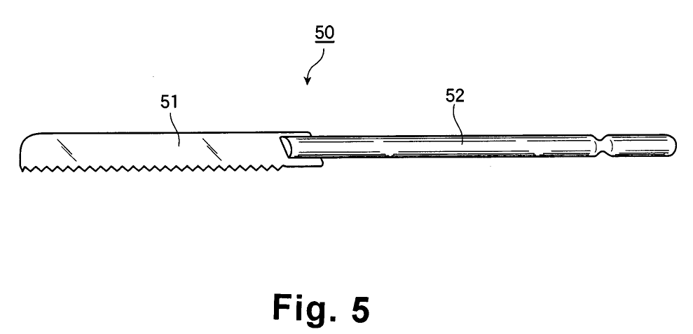

FIGS. 6(a) to 6(c) illustrate a conventional replacement blade and holder assembly in perspective, wherein FIG. 6(a) shows the blade member, FIG. 6(b) shows the shaft member, and FIG. 6(c) shows the assembled state.

### PREFERRED EMBODIMENTS OF THE INVENTION

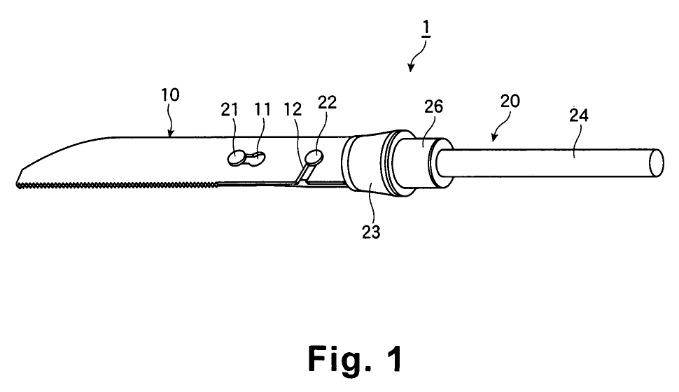

The present invention will now be explained in more detail with reference to a preferred embodiment taken in conjunction with the attached FIGS. 1 to 4.

The replacement blade and holder assembly 1 according to the present invention is, as shown in FIG. 1, composed of blade member 10 and holder 20. The blade member 10 is provided with elongate aperture 11 and slit 12, and the holder 20 is provided with first engagement pin 21 and second engagement pin 22. The blade member 10 is securely fixed to the holder 20 by means of the engagement between the elongate aperture 11 and the first engagement pin 21 and between the slit 12 and the second engagement pin 22, as well as by slide ring 23 (fixing end engagement member) of the holder 20 abutting the blade member 10.

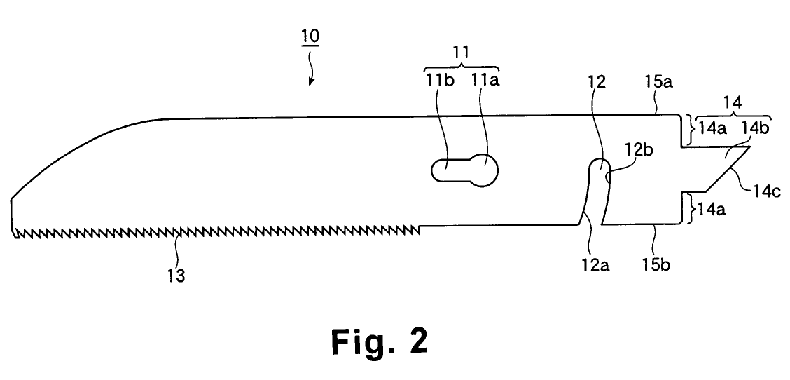

More specifically referring to FIG. 2, the blade member 10 has cutting edge 13 having sawteeth for cutting a treatment site, the elongate aperture 11 having large diameter portion 11a and small diameter portion 11b and penetrating generally in the middle of the blade member 10, slit 12 formed proximal to the elongate aperture 11 by cutting in the cutting edge side, and fixing end 14 having shoulders 14a and tang 14b at the proximal end.

The large diameter portion 11a of the elongate aperture 11 is sized to allow insertion and release of the head of the first engagement pin 21. The small diameter portion 11b is sized to be smaller than the diameter of the head of the first engagement pin 21 and to receive the shank of the first engagement pin 21 snugly without a gap.

The slit 12 is formed so as to fit on or to be released from the second engagement pin 22 when the blade member 10 is pivoted on the first engagement pin 21 fitted in the small diameter portion 11b of the elongate aperture 11. In a preferred embodiment, the slit 12 may be formed in a curved shape, and have arc 12a formed with the small diameter portion 11b as the center, and arc 12b of a curvature larger than that of the arc 12a. When the blade member 10 is pivoted on the first engagement pin 21 fitted in the elongate aperture 11, the arc 12a is on the radially inner side, and the arc 12b is on the radially outer side. Thus the difference in curvature facilitates engagement of the second engagement pin 22 in the slit 12.

The shoulders 14a are corners at generally right angles formed at the proximal end 15a of the back and at the heel 15b of the blade member 10. The slide ring 23 of the holder 20 abuts these shoulders 14a as will be discussed later. The proximal end of the tang 14b is canted to form oblique surface 14c, which is complementary to step 28 formed on the holder 20, as will be discussed below.

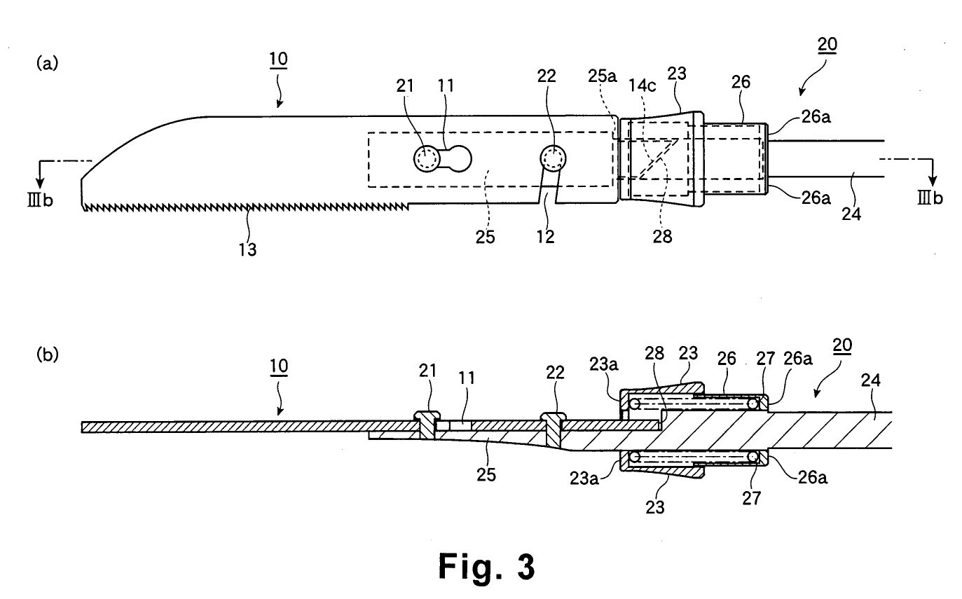

Referring to FIG. 3, the holder 20 includes the slide ring 23 and shaft body 24. The shaft body 24 has, in its distal portion, blade mounting portion 25 that has a width slightly larger than the rest of the shaft body 24. The blade mounting portion 25 is provided with the first and second engagement pins 21 and 22 protruding from the flat surface of the blade mounting portion 25, on which surface the blade member 10 is to be mounted. In the portion of the shaft body 24 covered by the slide ring 23, step 28 having an oblique surface is formed. The oblique surface of the step 28 is complementary to the oblique surface 14c of the tang 14b of the blade member 10, so that the two oblique surfaces face to each other. The proximal end of the shaft body 24 is connected to a reciprocating saw handpiece (not shown).

Housing member 26 is fixed around the shaft body 24 generally in the middle portion thereof, and the slide ring 23 is slidably disposed around the housing member 26. Spring 27 is disposed around the shaft body 24 and enclosed in the housing member 26 and the slide ring 23. The distal end of the spring 27 is supported on the supporting portion 23a formed at the distal end face of the slide ring 23, and the proximal end of the spring 27 is supported on the supporting portion 26a formed at the proximal end face of the housing member 26. The supporting portion 23a of the slide ring 23 has a through hole sized to have minimal clearance for the shaft body 24 inserted therethrough, and for the tang 14b of the-blade member 10. The slide ring 23 is constantly urged with the spring 27 distally with respect to the housing member 26 and the shaft body 24. Thus, when the blade member 10 is attached to the holder 20 as shown in FIG. 3, the supporting portion 23a abuts the shoulders 14a of the blade member 10 to inhibit unstable shaking of the blade member 10. When the blade member 10 is not attached to the holder 20, the supporting portion 23a abuts the proximal end face 25a of the blade mounting portion 25 to prevent the slide ring 23 from falling off.

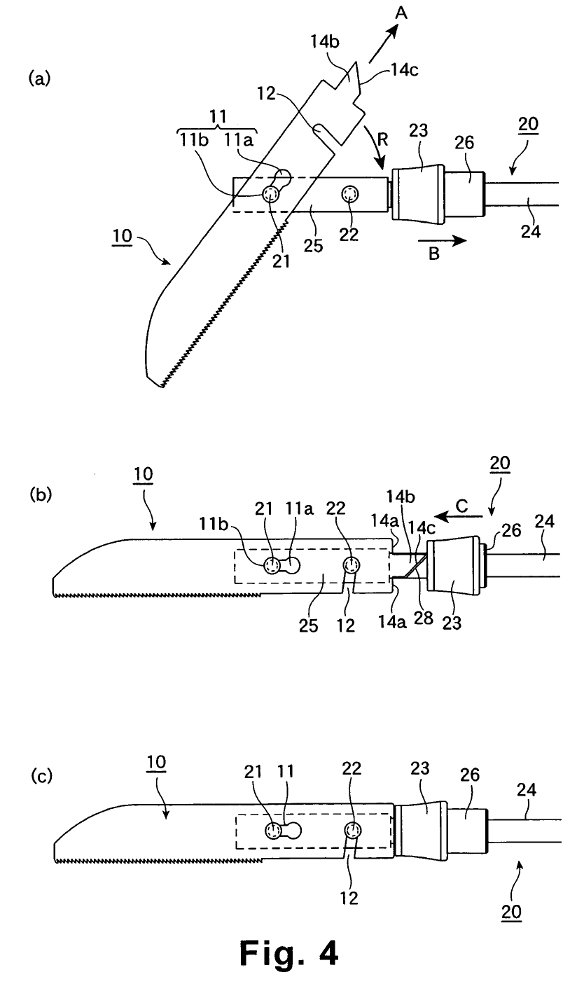

Referring to FIGS. 4(a) to 4(c), the operation for attaching and detaching the blade member 10 to and from the holder 20 in the replacement blade and holder assembly 1 for a reciprocating saw is explained below.

For attaching the blade member 10 to the holder 20, first the blade member 10 is positioned at a slant with respect to the holder 20 as shown in FIG. 4(a), and the first engagement pin 21 on the holder 20 is made to be inserted into the large diameter portion 11a of the elongate aperture 11 in the blade member 10. Then by sliding the blade member 10 in the direction of arrow A, the first engagement pin 21 fits in the small diameter portion 11b as shown in FIG. 4(a). From this state, the slide ring 23 is slid with fingers in the direction of arrow B, and the blade member 10 is pivoted on the first engagement pin 21 in the direction of arrow R. Through this operation, the slit 12 in the blade member 10 is fitted on the second engagement pin 22, and the oblique surface 14c of the tang 14b of the blade member 10 is arranged facing to the oblique surface of the step 28 of the holder 20, as shown in FIG. 4(b). Finally, when the slide ring 23 is released by removing the fingers, the slide ring 23 slides back in the direction of arrow C under the force of the spring 27 to fit over the tang 14b of the blade member 10, with the supporting portion 23a of the slide ring 23 pressing the shoulders 14a of the blade member 10, as shown in FIG. 4(c), to thereby complete attachment of the blade member 10.

For detaching the blade member 10 from the holder 20, the above procedure is followed in a reverse way.

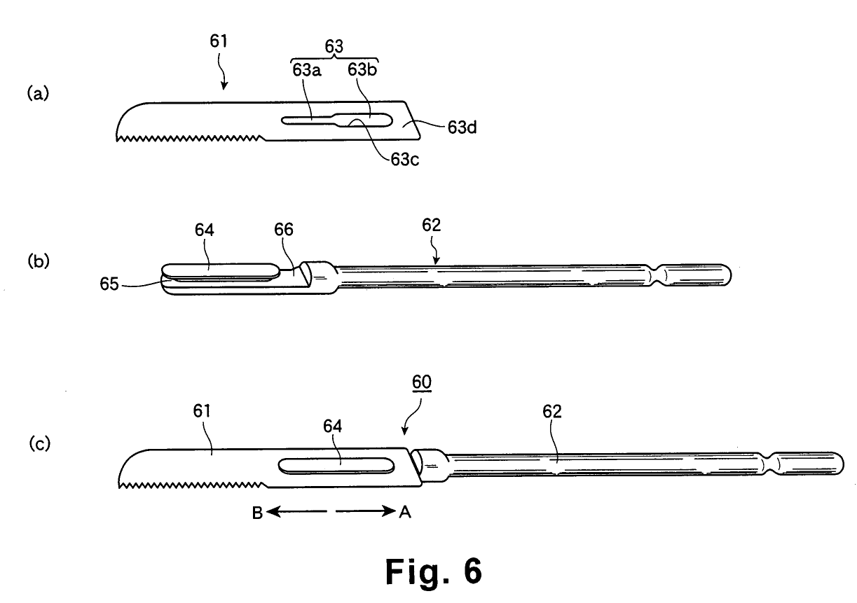

As discussed above, with the replacement blade and holder assembly 1 for a reciprocating saw, attachment and detachment of the blade member 10 to and from the holder 20 may be done simply by fitting and releasing the slit 12 on and from the second engagement pin 22 through pivoting of the blade member 10 on the first engagement pin 21 fitted in the elongate aperture 11, and by sliding the slide ring 23 upon the engagement operation. Thus the blade member 10 does not have to be flexed for attachment and detachment as in the prior art device shown in FIG. 6. According to the present invention, by employing the one-touch pivotal attachment/detachment mechanism as discussed above as the attachment/detachment mechanism of the blade member 10 to/from the holder 20, even when the blade member 10 is thick, rigid, and hard to flex, such a blade member may be used as a single-use replacement blade member, and easily attached to and detached from the holder 20.

Further, in the replacement blade and holder assembly 1 for a reciprocating saw, only the minimal clearance is required between the elongate aperture 11 and the first engagement pin 21 and between the slit 12 and the second engagement pin 22, and also between the fixing end 14 of the blade member 10 and the slide ring 23. Thus the blade member 10 is securely fixed to the holder 20. Further, axial displacement of the blade member 10 is restricted by the engagement of the first and second engagement pins 21 and 22 with the elongate aperture 11 and the slit 12, respectively, and lateral displacement of the blade member 10 is restricted by the engagement of the fixing end 14 of the blade member 10 with the slide ring 23. These restrictions also contribute to secure fixing of the blade member 10 to the holder 20.

Although the present invention has been described with reference to the preferred embodiment, it should be understood that various modifications and variations can be easily made by those skilled in the art without departing from the spirit of the invention. Accordingly, the foregoing disclosure should be interpreted as illustrative only and is not to be interpreted in a limiting sense. The present invention is limited only by the scope of the following claims.

What is claimed is:

1. A replacement blade and holder assembly for a reciprocating saw comprising:
a blade member having a cutting edge for cutting a treatment site, and
a holder to which said blade member is detachably fixed,
wherein said blade member has an elongate aperture and a slit,
wherein said holder has a first engagement pin protruding therefrom for detachably engaging in said elongate aperture in the blade member, and a second engagement pin protruding therefrom for detachably engaging in said slit in the blade member, and
wherein said holder has a fixing end engagement member for detachably engaging with a fixing end of the blade member to restrict lateral displacement of the blade member.

2. The replacement blade and holder assembly of claim 1, wherein said elongate aperture in the blade member has a large diameter portion having a diameter larger than the diameter of the first engagement pin on the holder for allowing insertion and release of the first engagement pin, and a small diameter portion having a diameter substantially the same as the diameter of the first engagement pin for holding and restricting displacement of the first engagement pin.

3. The replacement blade and holder assembly of claim 1, wherein said slit in the blade member is curved so as to allow insertion and release of the second engagement pin on the holder when the blade member is pivoted on the first engagement pin fitted in the elongate aperture.

4. The replacement blade and holder assembly of claim 1, wherein the fixing end engagement member is slidable, and is urged with an elastic member into engagement with the fixing end of the blade member.

5. Are placement blade for use with a holder in the assembly of claim 1, comprising a blade member to be detachably fixed to the holder having a first and second engagement pins, said blade member having a cutting edge for cutting a treatment site, an elongate aperture in which the first engagement pin on the holder is to be detachably engaged, and a slit in which the second engagement pin on the holder is to be detachably engaged.

6. A holder for use with a replacement blade in the assembly of claim 1, wherein said replacement blade having an elongate aperture and a slit is to be detachably fixed to said holder, said holder comprising a first engagement pin protruding there from for detachably engaging in the elongate aperture in the blade, a second engagement pin protruding therefrom for detachably engaging in the slit in the blade, and a fixing end engagement member for detachably engaging with a fixing end of the blade to restrict lateral displacement of the blade.
